(19) United States
(12) Patent Application Publication
(10) Pub. No.: US 2026/0268488 A1
(43) Pub. Date: Sep. 10, 2026

(54) SYSTEM AND METHOD FOR DETERMINING A CONDITION OF A FOOT OF AN ANIMAL

(71) Applicant: HOOFCOUNT LTD, Preston (GB)

(72) Inventors: Anthony MARSH, Preston (GB); John HARDIMAN, Preston (GB)

(21) Appl. No.: 19/165,795

(22) PCT Filed: Mar. 15, 2024
(86) PCT No.: PCT/GB2024/050713

§ 371 Date: Sep. 16, 2025

(30) Foreign Application Priority Data
Mar. 16, 2023 (GB) 2303883.9
Feb. 28, 2024 (GB) 2402850.8

(51) Int. Cl. G06T 7/00; A01K 11/00; A01K 13/00; A01K 29/00; B08B 1/16; B08B 1/30; B08B 5/02; G02B 27/00; G06V 10/70; G06V 40/10

(52) U.S. Cl. CPC G06T 7/0012; A01K 11/006; A01K 13/001; A01K 29/005; B08B 1/16; B08B 1/30; B08B 5/02; G02B 27/0006; G06V 10/70; G06V 40/10; G06T 2207/20081

(57) ABSTRACT

The present disclosure relates to livestock health, in particular, the present disclosure describes a system for determining a condition of at least one foot of an animal. An aspect of the disclosure provides a system for determining a condition of at least one foot of an animal, the system comprising: an image input configured to obtain one or more images, wherein a portion of each of the one or more images depicts at least one foot of the animal exiting a footbath; and an image analyser comprising a machine learning algorithm configured to determine the condition of the at least one foot of the animal based on the one or more images.

### FIELD OF DISCLOSURE

The present disclosure relates to livestock health, in particular, the present disclosure describes a system for determining a condition of at least one foot of an animal.

### BACKGROUND

Animals, for example, dairy cows. Farmers sell milk which they extract from the dairy cows.

An animal, such as a dairy cow, can develop conditions of the foot. The conditions of the foot can result in lameness of the animal. Conditions of the foot include: digital dermatitis; heel horn erosion; interdigital phlegmon; interdigital hyperplasia; sole haemorrhage; sole ulcer; white line disease; toe necrosis; toe ulcer; bulb ulcer; axial horn fissure; asymmetric claws; concave dorsal wall; corkscrew claws; interdigital/superficial dermatitis; double sole; heel horn erosion; horn fissure; axial horn fissure; horizontal horn fissure; vertical horn fissure; scissor claws; diffused form; sole haemorrhage circumscribed form; swelling of coronet and/or bulb; ulcer; sole ulcer; toe necrosis; thin sole; white line fissure; white line abscess; horn overgrowth; claw overgrowth; and, foreign bodies disposed in the hoof.

In the UK, farmers typically sell milk wholesale. The wholesale price of milk is given as pence per litre (ppl). The ppl of a given lot of milk depends on the overall mobility of the herd of cows which produce the lot of milk. Cows in a herd are each assigned a mobility score which is used to assess the overall mobility of the herd.

A mobility score is assigned to a cow. Typically a mobility inspector visits a farm to assign each cow in a herd with a mobility score. The mobility score is an integer value between 0 and 3.
A mobility score of 0 indicates a cow with good mobility.
A mobility score of 1 indicates a cow with imperfect mobility. A cow with imperfect mobility may have uneven steps but the affected limb is not immediately identifiable.
A mobility score of 2 indicates a cow with impaired mobility. A cow with impaired mobility may have uneven steps and the affected limb is identifiable.
A mobility score of 3 indicates a cow with severe impaired mobility. A cow with severe impaired mobility may be unable to keep up with a herd and the affected leg is easy to identify. In some cases a cow with severe impaired mobility may be unable to stand.

The ppl for a lot of milk produced by that herd is reduced based on each cow in the herd which is assigned a mobility score of 2 or 3. Therefore, to increase profits, farmers may wish to attempt to reduce the number of cows which have mobility scores of 2 and 3.

Financial losses attributed to lameness include: reduced fertility of cows; reduced milk yields; treatment costs; and, early culling. Furthermore, poor mobility reduces overall animal welfare of the cows and may result in a higher carbon footprint.

Early detection of the conditions of the feet of the animals may lead to earlier treatment and therefore reduce one or more of the financial losses set out above.

One way to reduce the number of cows which are assigned a mobility score of 2 or 3 is to use the so-called ‘Spot-Lift-Look’ method to identify a condition of the foot of the cow and to subsequently treat the identified conditions of each of the cows with conditions.

The ‘Spot-Lift-Look’ method comprises: spotting that a cow has become lame; manual lifting the foot of the cow, usually with the cow disposed in a crush; looking at the foot and attempting to identify a condition of the foot.

One disadvantage associated with the ‘Spot-Lift-Look’ method is that it requires sufficient experience to spot a cow has become lame. Furthermore, a cow may mistakenly be identified as having become lame, but upon moving the cow into a crush and lifting the foot it is discovered that the cow does not in fact have a condition of the foot. Therefore, the ‘Spot-Lift-Look’method can be relatively time consuming.

Another disadvantage associated with the ‘Spot-Lift-Look’ may be inaccurate, either upon lifting the foot no condition is identified or upon lifting the foot a condition identified is not the same as the actual condition of the foot.

### SUMMARY

The present invention is defined by the appended independent claims. Optional features are set out in the dependent claims.

An aspect of the disclosure provides a system for determining a condition of at least one foot of an animal, the system comprising: an image input configured to obtain one or more images, wherein a portion of each of the one or more images depicts at least one foot of the animal exiting a footbath; and an image analyser comprising a machine learning algorithm configured to determine the condition of the at least one foot of the animal based on the one or more images.

An aspect of the disclosure provides a system for determining a condition of at least one foot of an animal, the system comprising: an image input configured to obtain one or more images, wherein a portion of each of the one or more images depicts at least one foot of the animal; and an image analyser comprising a machine learning algorithm configured to determine the condition of the at least one foot of the animal based on the one or more images.

In examples, the one or more images obtained by the image input may be frames of a video (e.g. captured by a camera).

Embodiments of the system may permit the condition of the at least one foot of an animal to be determined based on one or more images. The system may permit a condition of a foot (or feet) of an animal (or animals) to be determined. Advantageously, a human may not be required to determine a condition of the foot of an animal, which may save time and/or reduce costs e.g. the time taken and/or cost of a human to determine a condition of the feet of an animal may be avoided (e.g. the Spot-Lift-Look). Advantageously, the system may more accurately determine conditions of the foot of an animal in comparison to a human e.g. the system may make fewer incorrect determinations of a condition of the foot of an animal in comparison to a human.

In examples, the one or more images may be one or more frames of a video (e.g. captured by a camera).

Examples herein provide a system for determining a condition of at least one foot of an animal, the system comprising: a video input configured to obtain a video (e.g. one or more images from a video), wherein a portion of each frame from the video depicts at least one foot of the animal; and an image analyser comprising a machine learning algorithm configured to determine the condition of the at least one foot of the animal based on the one or more frame from the video. In examples, the animal may be exiting a footbath (e.g. or stepping over another obstacle) when the video is obtained of the at least one foot of the animal.

Provided herein is a method for determining a condition of at least one foot of an animal, the method comprising: obtaining a video (e.g. one or more images from a video), wherein a portion of each of each from the video depicts at least one foot of the animal; and determining with a machine learning algorithm the condition of the at least one foot of the animal based on the one or more frame from the video. In examples, the animal may be exiting a footbath (e.g. or stepping over another obstacle) when the video is obtained of the at least one foot of the animal.

The machine learning algorithm may be configured to: perform image recognition on the obtained one or more images to identify the at least one foot of the animal in each of the one or more images; and, determine the condition of the at least one foot of the animal based on the identified at least one foot of the animal in the at one or more images.

The machine learning algorithm may be configured to: perform image recognition on the obtained one or more images to identify the at least one foot of the animal in each of the one or more images by identifying the portion of each of the one or more image which depicts at least one foot of the animal exiting the footbath.

The machine learning algorithm may comprise an object detection algorithm. The object detection algorithm may be suitable for real-time object detection, for example, an algorithm which can detect objects in images within a few seconds, for example, within at most 1 second. In examples, the algorithm generate results (e.g. detection of a condition of at least one foot of the animal) with 24 hours. The object detection algorithm may be a single-shot detector (SSD) algorithm that uses a convolutional neural network (CNN) to process an image. For example, the object detection algorithm may be a You Only Look Once (YOLO) algorithm which may perform image recognition in a shorter period of time compared to other object detection algorithms.

In examples, the condition may be determined using a machine learning algorithm configured to characterise movement of the animal. The algorithm may be trained on data indicative of animals having a variety of foot conditions. For example, one or more videos comprising a plurality of images (e.g. frames) of an animal of a given type (e.g. cow) with no foot condition, one or more videos comprising animal of the given type with a first condition (e.g. digital dermatitis), one or more videos comprising an animal of the given type with a second condition (e.g. heel horn erosion) etc. may be used as training data for the machine learning algorithm. For example, the aforementioned videos may be provided with labels indicating the condition of the animal depicting in the video.

In this way a machine learning algorithm may be provided which may assess the perceived movement of the animal (i.e. between successive frames of the images) to determine if the animal has a condition. For example, one or more videos of an animal of a given type with a first condition may depict an animal moving in a particular manner (e.g. indicative of the condition, such as limping on one or more feet). By using the label of the first condition and determining the movement of the animal (e.g. the difference of the animal's position between frames of the video) then a correlation can be provided between the movement of the animal and the condition. This process may be repeated for the same type of animal (e.g. cow) with different conditions and also for the same type of animal which is healthy (e.g. no foot condition) thereby to provide an algorithm which is able to determine a condition of a foot of an animal based on one or more images (e.g. a video) of the animal.

Examples herein provide a system for determining a condition of at least one foot of an animal, the system comprising: an video input configured to obtain a video (e.g. one or more images from a video), wherein a portion of a plurality of frames from the video depicts at least part of the animal; and an image analyser comprising a machine learning algorithm configured to determine the condition of the at least one foot of the animal based on the plurality of frames from the video.

An aspect of the disclosure provides a method for determining a condition of at least one foot of an animal, the method comprising: obtaining a video, wherein a portion of a plurality of frames from the video depicts at least part of the animal; and determining with a machine learning algorithm the condition of the at least one foot of the animal based on the plurality of frames from the video.

In examples, a video (or one or more images) does not need to depict a foot of the animal but instead can just show a portion of the animal (e.g. an upper portion of the animal) and the algorithm may determine a gait of the animal. Based on the gait of the animal the algorithm may determine that the animal does or does not have a condition of the foot.

The system may comprise a display for displaying the condition of the at least one foot of the animal i.e. the condition determined by the system.

The image input may be a camera. The camera may be arranged obtain an image of the images depicts at least one foot of the animal exiting a footbath.

The camera may receive light for obtaining an image via a window; and, wherein the system may comprise: a window clearing assembly configured to clear the window.

The window may be a lens of the camera. The window may be separate from the camera disposed. The camera may be disposed in a box (e.g. to protect the camera from liquid and debris) and a side of the box opposite a lens of the camera comprises the window.

The window clearing assembly may comprise at least one of: a movable member configured to wipe the window to thereby clear the window; the window clearing assembly comprises an air blower configured to blow air on the window to thereby clear the window. The air blown on the window may dislodge debris from the window and/or it may dry liquid on the window which advantageously improve the depiction of the foot (or feet) in the one or more images which may improve the accuracy of the determination of the condition of the at least one foot of the animal.

The window clearing assembly may comprise a liquid dispenser configured to dispense a liquid (e.g. water and/or a chemical solution) onto the window to thereby clear the window. The liquid dispenser may dispense a liquid onto the window (e.g. poured and/or forced under pressure and/or sprayed). The dispensed liquid may dislodge debris from the window. The liquid dispenser may dispense a clear (e.g. transmits one or more light wavelengths detectable by a camera) liquid onto the window which may dislodge debris and/or displace another fluid (e.g. a dirty fluid) which advantageously may improve the depiction of the foot (or feet) in the one or more images which may improve the accuracy of the determination of the condition of the at least one foot of the animal.

The sensor may be configured to generate a signal in the event that an animal is sensed by the sensor within a sensing region of the sensor, wherein the camera is configured to obtain an image in response to the signal.

The sensing region of the sensor may overlap a field of view of the camera and the camera may be configured to capture an image after receiving the signal (e.g. there is no delay between the receipt of the signal and the camera obtaining one or more images by the camera) which may ensure that the one or more images captured may depict the foot (or feet) of the animal. The sensing region of the sensor may overlap part of the footbath and the camera may be configured to capture one or more images after a preselected delay (e.g. a second, or two seconds or three seconds) so that the which may ensure that the one or more images.

The camera may be configured to obtain a plurality of images at a preselected image capture rate and for a preselected period of time in response to receipt of the signal.

The sensor may be an infrared (IR) sensor (e.g. an active IR sensor or a passive IR sensor (PIR sensor)).

The data collection apparatus may comprise: a first sensor configured to generate a first signal in the event that an animal is sensed by the first sensor within a first sensing region of the first sensor; and, a second sensor configured to generate a second signal in the event that an animal is sensed by the second sensor within a second sensing region of the second sensor; wherein the camera is configured to: start obtaining images in response to the first signal; cease obtaining images in response to the second signal;

The camera may be configured to begin obtaining a plurality of images at a preselected image capture rate in response to receipt of the first signal and ceasing to obtain a plurality of images in response to receipt of the second signal.

The image input may be a port configured to receive one or more images obtained from a camera. The port may be configured to connect to a camera and to receive images from the camera.

It will be appreciated that a plurality of images may be a video (e.g. merely a series of images obtained at a selected frame rate).

The footbath may comprise: an entrance side wherein an animal steps over the entrance side to enter the footbath; and, an exit side wherein an animal steps over the exit side to exit the footbath, and wherein the exit side is disposed opposite the entrance side so that during use the animal moves in movement direction, wherein the movement direction is defined from the entrance side towards the exit side; and, wherein the camera is disposed at the exit side of the footbath and arranged to view in the movement direction.

Providing an exit side which requires an animal to step over the exit side ensures that a foot of the animal is raised which may permit the foot (e.g. the sole or hoof of the foot) to be depicted in the one or more images which may permit a condition to be determined.

The system may comprise one or more lights configured to illuminate a foot (or feet) of the animals. The one or more lights may be arranged to emit light in the movement direction. Advantageously, illuminating the foot may improve the depiction of the foot in the one or more images which may improve the accuracy of the determination of the condition of the at least one foot of the animal.

The system may comprise one or more filters (e.g. polarising filters) disposed over at least one of a camera lens and one or more of the lights. The one or more filters may improve the quality of the images obtained which may in turn improve the determination of the condition of the foot of the animal.

The system may comprise: an identifier reader configured to read an identifier from an identifier tag disposed on the animal; and wherein the system is configured to generate an associated condition wherein the associated condition comprises a condition and an associated identifier.

The identifier tag may be a radio frequency identification (RFID) tag. The identifier tag may be disposed on the animal (e.g. in an ear or a subdermal implant).

The associated condition may be stored in a storage location. The storage location may comprise an identity profile associated with each unique animal. The identity profile may comprise a plurality of associated conditions associated with a given animal. The identity profile may comprise a timeline of the conditions of the animal

A display device may be configured to retrieve an identity profile associated with a unique animal. The display device may be configured to send a request for an identity profile wherein the request comprises an identifier of the animal. The storage location may be configured to send the identity profile to the display device in response to the request. The identity profile may comprise a timeline indicating the condition against a time axis e.g. data showing no condition at a first time, data showing a condition having at a second time.

The system may further comprise: a dispenser configured to dispense a substance into the footbath, wherein the dispenser is configured to dispense the substance into the footbath based on the associated identifier. The associated identifier is associated with a condition of the animal. The substance may be configured to treat the condition of the foot of the animal. Advantageously, the system may treat a condition of the foot of the animal.

The dispenser may be configured to: dispense a given amount of the substance into the footbath based on the associated identifier. Advantageously, an appropriate amount of substance can be dispensed into the footbath to treat the foot of the animal.

The system may further comprise: a gate for separating animals, wherein the gate is switchable between a first position and a second position, wherein: the first position permits an animal to access a first region and prevents the animal to access a second region; and, the second position permits the animal to access a second region and prevents the animal to access a first region; and, the gate is configured to receive the identifier; the gate is switchable between the first position and the second position based on the associated identifier.

The first region may be a holding pen to permit further inspection (e.g. manual inspection) of the animal or to permit treatment of the condition of the animal. The second region may be to a field or barn or the like for animals which do not need to be treated. Advantageously, the system may automatically separate healthy animals (i.e. animals with no foot conditions) from unhealthy animals (i.e. animals with at least one foot conditions) which may save time and/or money for famers and/or veterinarians who may seek to separate animals on this basis.

The animal may be a cattle animal such as a cow (e.g. a dairy cow). The condition may digital dermatitis of cattle. The condition may be any of: digital dermatitis; heel horn erosion; interdigital phlegmon; interdigital hyperplasia; sole haemorrhage; sole ulcer; white line disease; toe necrosis; toe ulcer; bulb ulcer; axial horn fissure; asymmetric claws; concave dorsal wall; corkscrew claws; interdigital/superficial dermatitis; double sole; heel horn erosion; horn fissure; axial horn fissure; horizontal horn fissure; vertical horn fissure; scissor claws; diffused form; sole haemorrhage circumscribed form; swelling of coronet and/or bulb; ulcer; sole ulcer; toe necrosis; thin sole; white line fissure; white line abscess; horn overgrowth; claw overgrowth; and, foreign bodies disposed in the hoof.

An aspect of the disclosure provides a method for determining a condition of at least one foot of an animal, the method comprising: obtaining one or more images, wherein a portion of each of the one or more images depicts at least one foot of the animal exiting a footbath; and determining with a machine learning algorithm the condition of the at least one foot of the animal based on the one or more images.

An aspect of the disclosure provides a method for determining a condition of at least one foot of an animal, the method comprising: obtaining one or more images, wherein a portion of each of the one or more images depicts at least one foot of the animal; and determining with a machine learning algorithm the condition of the at least one foot of the animal based on the one or more images.

In examples, the one or more images obtained may be frames of a video (e.g. captured by a camera).

Embodiments of the method may permit the condition of the at least one foot of an animal to be determined based on one or more images. The system may permit a condition of a foot (or feet) of an animal (or animals) to be determined. Advantageously, a human may not be required to determine a condition of the foot of an animal, which may save time and/or reduce costs e.g. the time taken and/or cost of a human to determine a condition of the feet of an animal may be avoided (e.g. the Spot-Lift-Look). Advantageously, the method may more accurately determine conditions of the foot of an animal in comparison to a human e.g. the method may make fewer incorrect determinations of a condition of the foot of an animal in comparison to a human.

The method may further comprise: determining with a machine learning algorithm the condition of the at least one foot of the animal based on the one or more images comprises: performing image recognition on the obtained one or more images to identify the at least one foot of the animal in each of the one or more images; and, determining the condition of the at least one foot of the animal based on the identified at least one foot of the animal in the at one or more images.

The method may further comprise performing image recognition on the obtained one or more images to identify the at least one foot of the animal in each of the one or more images comprises: performing image recognition on the obtained one or more images to identify the at least one foot of the animal in each of the one or more images by identifying the portion of each of the one or more image which depicts at least one foot of the animal exiting the footbath.

The machine learning algorithm may comprise an object detection algorithm.

The method may comprise: sensing an animal; and, obtaining an image in response to sensing the animal.

The method may comprise: sensing an animal in a first location; sensing an animal in a second location; starting to obtain images in response to sensing the animal in the first location; ceasing to obtain images in response to sensing the animal in the second location.

The method may comprise: sensing an animal in a first location; starting to obtain images in response to sensing the animal in the first location; ceasing to obtain images in response to no longer sensing the animal in the first location.

The method may comprise: identifying an animal; associating the identified animal and the condition. Identifying an animal may comprise reading an identifier (e.g. an RFID tag).

The method may comprise: dispensing a substance into the footbath based on the identity of the animal.

The method may comprise: operating a gate for separating animals based on the identity of the animal.

An aspect of the disclosure provides a computer program product configured to perform any of the methods described herein.

An aspect of the disclosure provides a computer program product configured to determine with a machine learning algorithm a condition of at least one foot of an animal based on one or more images comprises: performing image recognition on the obtained one or more images to identify the at least one foot of the animal in each of the one or more images; and, determining the condition of the at least one foot of the animal based on the identified at least one foot of the animal in the at one or more images.

Embodiments of the computer program product may permit the condition of the at least one foot of an animal to be determined based on one or more images. The product may permit a condition of a foot (or feet) of an animal (or animals) to be determined. Advantageously, a human may not be required to determine a condition of the foot of an animal, which may save time and/or reduce costs e.g. the time taken and/or cost of a human to determine a condition of the feet of an animal may be avoided (e.g. the Spot-Lift-Look). Advantageously, the product may more accurately determine conditions of the foot of an animal in comparison to a human e.g. the product may make fewer incorrect determinations of a condition of the foot of an animal in comparison to a human.

An aspect of the disclosure provides a computer program product configured to perform any of the methods described herein.

### BRIEF DESCRIPTION OF DRAWINGS

Some examples will now be described, by way of example only, which reference to figures, in which:

FIG. 1A illustrates a top-down plan view of the system;

FIG. 1B illustrates a top-down plan view of the image input, window, and window clearing assembly of the system shown in FIG. 1A;

FIG. 1C illustrates a side plan view of the image input, window, and window clearing assembly of the system shown in FIG. 1B;

FIG. 2 illustrates an image with a rectangle identifying the portion of the image which depicts a foot of the animal;

FIG. 3A illustrates an associated condition;

FIG. 3B illustrates a profile;

FIG. 4 illustrates a flowchart illustrating a method of determining a condition of at least one foot of an animal.

In the drawings like reference signs indicate like elements.

### SPECIFIC DESCRIPTION

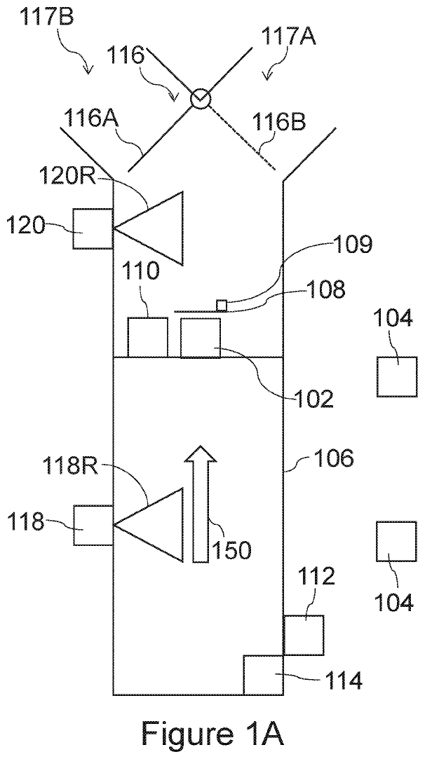

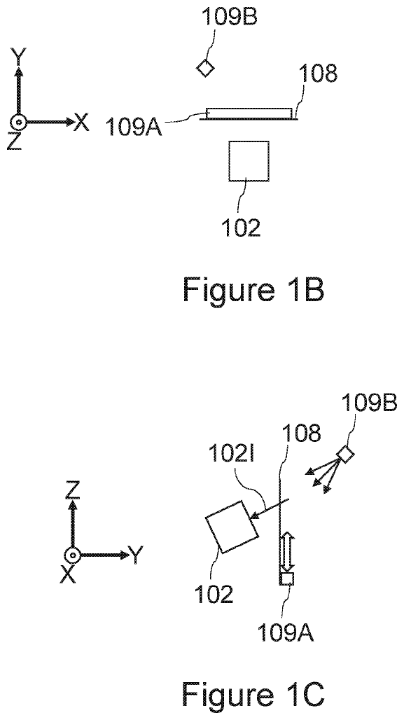

The present disclosure relates to a system 100 and method for determining a condition of at least one foot of an animal. FIG. 1A illustrates a top-down plan view of the system 100; FIG. 1B illustrates a top-down plan view of the image input 102, window 108, and window clearing assembly 109 of the system 100; FIG. 1C illustrates a side plan view of the image input 102, window 108, and window clearing assembly 109 of the system 100.

The system 100 for determining a condition of at least one foot of an animal. The system 100 comprises: an image input 102; an image analyser 104; a footbath 106; a window 108; a window clearing assembly 109; one or more lights 110; an identifier reader 112; a dispenser 114; a gate 116; a first sensor 118; a second sensor 120; and, a computing device 122.

The image input 102 obtains one or more image wherein a portion of each of the each of the one or more images depicts at least one foot of the animal exiting a footbath. The one or more images are provided to the image analyser 104 which comprises a machine learning algorithm configured to determine the condition of the at least one foot of the animal based on the one or more images.

The machine learning algorithm of the image analyser 104 is a computer vision algorithm (e.g. You Only Look Once (YOLO) algorithm). The algorithm comprises a model which is generated from training data. The training data may comprise images of cow feet without digital dermatitis wherein each image comprises a label indicating that the image depicts cow feet without digital dermatitis and images of cow feet with digital dermatitis wherein each image comprises a label indicating that the image depicts cow feet with digital dermatitis. In this manner a model can be trained which can be used to determine if a given image of a cow foot depicts a cow foot with or without digital dermatitis.

The image analyser 104 can be configured to isolate a portion of an image which depicts a cow foot. The portion of the image depicting the cow foot can then be provided to the machine learning algorithm.

The footbath 106, window 108, window clearing assembly 109, one or more lights 110 aim to improve the depiction of the at least one foot of the animal in the one or more images to thereby improve the determination (e.g. the accuracy of the determination) of the condition. The footbath 106 holds a liquid such as water which cleans the feet of the animal which walk through the footbath. The window 108 may prevent liquid or debris from covering the field of view of a camera, and similarly, the window clearing assembly 109 removes liquid and debris disposed on the window 108. The one or more lights 110 illuminate the feet of the animal exiting the footbath 106.

The window may form part of a box within which the camera is disposed. In such examples, the upper surface of the box may be angled so that liquid and/or debris falling on the box is directed away from the window.

The first sensor 118 and the second sensor 120 may ensure that the one or more images obtained depict the animal and preferably at least one foot of the animal. Inclusion of the first sensor 118 and the second sensor 120 may prevent obsolete frames from being obtained (e.g. when the animal is out of the field of view of the image input 102). The system and method are described in more detail below.

The computing device 122 is receives and stores information indicative of the identity of each animal and, associated with each identifier, the condition of the feet of each animal.

As The system 100 comprises: an image input 102; an image analyser 104; a footbath 106; a window 108; a window clearing assembly 109; one or more lights 110; an identifier reader 112; a dispenser 114; a gate 116; a first sensor 118; a second sensor 120.

The footbath 106 comprises an entrance side 106A, an exit side 106B, a first side 106C, and a second side 106D. The entrance side 106A, exit side 106B, first side 106C and second side 106D are walls. The entrance side 106A and exit side 106B are connected to each other by the first side 106C and the second side 106D to form a reservoir for holding liquid therebetween. The liquid may comprises water for cleaning the feet of animals which step into the footbath 106. The liquid may also comprise a chemical for treating a condition of the feet of the animal. For example, the chemical may be formaldehyde for treating digital dermatitis.

Animals are introduced to the footbath 106 at the entrance side 106A and may only be able to exit the footbath 106 by crossing over the exit side 106B. Animal move in a movement direction 106M, wherein the movement direction 106M is defined from the entrance side 106A towards the exit side 106B. Animals will need to step over the exit side 106B in order to exit the footbath 106 which means that the animals will need to raise their feet to exit the footbath 106. Typically when stepping over an obstacle (e.g. the exit side 106B), the bottom of the foot of an animal is observable from the rear of the animal. In examples, where the animals are cows, the exit step may preferably be approximately 20 cm (approximately 8 inches) which may force the animal to raise and expose the underside of its foot sufficiently for the camera to obtain suitable images of the foot for a determination of the condition to be made.

Typically when the footbath 106 is arranged for use by cows, the footbath 106 may be disposed in a cattle race. A cattle race is an enclosed passageway which permits a cow (or other cattle animal) to move forwards but does not allow them to turn around. Conveniently disposing the footbath in a cattle race may encourage cows to move through the footbath 106 in the movement direction 106M.

The image input 102 is configured to obtain one or more images. The image input 102 is a camera. In order for a determination to be made of a condition of at least one foot of the animal, a portion of at least one of the images should depict a foot of the animal. In the example shown in FIG. 1A, the camera is disposed at the exit side of the footbath to and arranged to view in the movement direction.

FIG. 1B illustrates a top-down plan view of the image input, window, and window clearing assembly of the system shown in FIG. 1A and FIG. 1C illustrates a side plan of the arrangement shown in FIG. 1B. FIG. 1C illustrates an input (e.g. lens) of the camera 1021. The camera 102 may be positioned to obtain images from the underside of the foot of the animal. As shown in FIG. 1C the input 1021 is disposed obliquely to horizontal (e.g. floor of a cattle race). The input 1021 is “looking-up” to improve depiction of the bottom of the foot of the animal in the obtained images. This is an advantage because some conditions only present visible symptoms on the bottom of the foot of the animal e.g. where the hoof is located.

Arranging the image input 102 in this manner may permit images with a portion depicting one or more foot of the animal exiting the footbath to be obtained, and may for example, permit one or more images depicting the bottom the animal's foot to be obtained. This is an advantage because some conditions only present visible symptoms on the bottom of the foot of the animal e.g. where the hoof is located.

The one or more lights 110 are arranged to illuminate a foot or feet of the animal. The one or more lights 110 are arranged to emit light in movement direction 106M. The lights are disposed adjacent to the exit side 106B of the footbath 106. Advantageously, illuminating the foot or feet using the one or more lights may improve the depiction of the foot or feet in the one or more images which may improve the accuracy of the determination of the condition of the at least foot or feet of the animal.

The camera 102 is disposed behind a window 108. The window 108 is too transparent to permit the camera 102 to obtain images therethrough. The window 108 prevents liquid and debris from covering the camera 102 e.g. to keep the lens of the camera clean. Also provided is a window clearing assembly 109 comprising a movable member 109A and an air blower 109B.

The moveable member 109A is configured to wipe the window 108 to thereby clear the window e.g. the movable member 109A moves along the surface of the window 108 to push liquid and/or debris off the window 108. The air blower 109B is configured to blow air onto the window 109 to thereby clear the window e.g. the air may dislodge debris from the window 108 and/or may dry liquid on the window 108. The window clearing assembly 109 is configured to clear the window to improve the depiction of the foot (or feet) in the one or more images which may improve the accuracy of the determination of the condition of the at least one foot of the animal.

A liquid dispenser may be provided in addition to, or in place of, the air blower 109b and/or the moveable member 109A.

The liquid dispenser may be configured to dispense a liquid onto the window (e.g. poured and/or forced under pressure). The dispensed liquid may dislodge debris from the window. The liquid dispenser may dispense a clear liquid onto the window which may dislodge debris and/or displace another fluid (e.g. a dirty fluid). For example, the other fluid (e.g. the dirty fluid) may transmit one or more light wavelengths detectable by a camera to a lesser degree than the dispensed liquid (e.g. the clear fluid). The other fluid may comprise mud (e.g. a solid comprising organic compounds) and/or water entrained with solids which may be splashed or dropped onto the window by the movement of the animals. The dispensed fluid may be water (e.g. tap water or the like) which is optically clearer than the other fluid. In the present example, the image input 102 is a camera, but it will be appreciated that in examples the image input may not be a camera. In such examples, the image input may obtain images either, via a wired connection (e.g. directly from a camera or a storage location), or via a wireless connection (e.g. from a camera or a storage location).

The image input 102 is configured to provide the one or more images to the image analyser 104. The image analyser 104 is configured to receive the one or more images from the image input 102. The image input 102 may be connected to the image analyser 104 by a wired connection and/or a wireless connection, wherein the connection is suitable for transferring the one or more images to the image analyser 104.

The image analyser 104 comprises a machine learning algorithm configured to determine the condition of the at least one foot of the animal based on the one or more images. The machine learning algorithm is an object detection algorithm which is trained using training data. A detailed description of the objection detection algorithm and the training data is set out elsewhere.

The machine learning algorithm is configured to perform image perform image recognition on the obtained one or more images to identify the at least one foot of the animal in each of the one or more images and to determine the condition of the at least one foot of the animal based on the identified at least one foot of the animal in the at one or more images. For each image, the machine learning algorithm may identify every instance of a foot in each of the images and then determine the condition (e.g. if a given condition A is present or not present) for each identified instance of a foot in each image.

The image analyser 104 may comprise a pre-processor for simplifying the operations on the one or more images of the at least one foot of the animal. For example, the pre-processor may remove blurry images which would not yield reliable determinations of the condition. The pre-processor may identify a best image upon which a determination of a condition can be made (e.g. an image showing the foot raised to a maximum height of a step of the animal, showing a view of the bottom of the foot) and remove the remaining images, thereby advantageously reducing the number of images to the analysed by the image analyser.

The machine learning algorithm is configured to perform image recognition on an obtained image to identify the at least one foot of the animal in the image. The image recognition comprises identifying the portion of the image which depicts at least one foot of the animal exiting the footbath. Identifying the portion of the image which depicts a foot may comprise identifying a rectangle of the image which depicts the foot, for example, by providing a bottom-left coordinate BC indicative of the position of the bottom-left pixel of the rectangle within the image and a size coordinate SC indicative of the size of the rectangle.

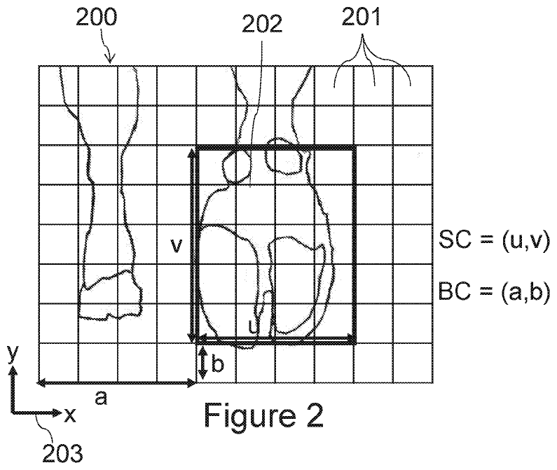

FIG. 2 illustrates an image 200 with a rectangle 202 identifying the portion of the image which depicts a foot of the animal. The image 200 comprises a plurality of pixels 201 arranged in a grid having an x-direction and a y-direction indicated by axes 203. The size and position of the rectangle 202 (i.e. its size coordinate SC and its bottom-left coordinate BC respectively) are determined by the machine learning algorithm. The size and position of the rectangle 202 are selected to encompass the fewest number of pixels (in a rectangular configuration) which depict the foot of the animal.

The bottom-left coordinate BC of the rectangle 202 may be given as (a, b) where a is the distance in the x-direction of the bottom-left pixel of the rectangle 202 from the bottom-left pixel of the image and where b is the distance in the y-direction of the bottom left pixel of the rectangle 202 from the bottom-left pixel of the image). The size coordinate of the rectangle may be given as (u, v) where u is the length (i.e. extent in the x direction) of the rectangle in terms of number of pixels and v is the height (i.e. extent in the y direction) of the rectangle in terms of number of pixels). More than one portion of the image (i.e. more than one rectangle) if the machine learning algorithm determines that there is more than one foot depicted in the image.

The machine learning algorithm is configured to determine the condition of the foot of the animal based on the portion of the image identified previously. For example, the machine learning algorithm performs analysis on each of the identified portion indicated by the size and bottom-left coordinates SC and BC to make a determination whether the portion depicts a condition of the foot or no condition of the foot. The machine learning algorithm may compare the portion of the image to a trained model and based on the comparison determine if the portion of the image indicates that the foot has a condition or does not have a condition.

The trained model may be generated using training data. A detailed description of training the machine learning model using training data is set out herein.

The first sensor 118 has a first sensing region 118R. The first sensor 118 is configured to generate a first signal in the event that an animal is sensed by the first sensor 118 within a first sensing region 118R. Similarly, the second sensor 120 is configured to generate a second signal in the event that an animal is sensed by the second sensor 120 within a second sensing region 120 of the second sensor. The first and second sensor may be infrared (IR) sensors (e.g. an active IR sensor or a passive IR sensor (PIR sensor)) or LIDAR (Light Detection And Ranging) sensors. The first sensing region and second sensing region may be a conical region with a vertex of the cone disposed at a sensor input (e.g. a lens) of the sensor, wherein the cone extends obliquely or perpendicular to the movement direction 106M.

The second sensor 120 is displaced from the first sensor 118 in the movement direction 106M so that the second sensing region 120R is displaced from the first sensing region 118R in the movement direction 106M. This arrangement ensures that the first sensor 118 is triggered (e.g. generates a first signal) before the second sensor 120 is triggered.

The first sensing region 118R and the second sensing region 120R extend into a region wherein the animals will be forced to move through (e.g. the footpath or another part of a cattle race). As shown in FIG. 1A, the first sensor 118 is disposed adjacent to the footbath 106 so that the first sensing region 118R overlaps part of the footbath 106. The second sensor 120 is disposed adjacent the cattle race so that the second sensing region 120R overlaps the cattle race in front of the exit side 106B of the footbath i.e. the second sensing region 120R is displaced from the exit side 106B in the movement direction 106M.

The first signal is sent from the first sensor 118 to the camera 102. the camera is configured to start obtaining images (e.g. recording a video) in response to the first signal. The second signal is sent from the second sensor 120 to the camera 102. The relative arrangement of the first sensor 118 and the second sensor 120 (i.e. the second sensor 120 displaced from the first sensor 118 in the movement direction 106M) ensures that the first signal is generated and sent to the camera before the second signal is generated and sent to the camera.

Arranging the first sensing region 118 in the footbath 106 causes the camera to start obtaining images before the foot (or feet) of the animal are within the field of view of the camera 102. Arranging the second sensing region 120R displaced from the exit side 106B in the movement direction 106M causes the camera to cease obtaining images after the foot (or feet) of the animal have been in the field of view of the camera 102.

Thus the arrangement of the first sensor 118 and second sensor 120 may permit one or more images depicting one or more foot of the animal to be obtained whilst reducing the number of images which are obtained which do not depict a foot of the animal or which may show poor quality images of one or more foot (e.g. where the foot is too far away from the camera). Advantageously this may reduce the work done by the image analyser.

The first and second sensors can be replaced with a single sensor configured to generate a sensing signal in response to sensing an animal in the sensing region of the sensor. The sensing region of the sensor may be disposed in the footbath, or overlapping the exit side of the footbath or displaced from the exit side of the footbath in the movement direction. The signal may be sent to the camera which may obtain one or more images for a selected period of time (e.g. 10 seconds). The selected period of time may be selected based on the position of the sensing region e.g. the selected period of time may be longer if the sensing region is in the footbath compared to if the sensing region is at the exit side of the footbath. The camera may obtain one or more images after a selected delay has elapsed after the receipt of the sensing signal. The delay may be selected based on the position of the sensing region e.g. the delay may be longer if the sensing region is in the footbath compared to if the sensing region is at the exit side of the footbath.

The identifier reader 112 is arranged to read an identifier from an identifier tag disposed on the animal. The identifier reader 112 is arranged adjacent to the footbath to obtain the identifier from the identifier tag. In the present example, the identifier tag is a radio frequency identification (RFID) tag disposed on the animal (e.g. in an ear of the animal). The identifier is unique to and indicative of a given individual animal.

The identifier may read by the identifier reader 112 may be used in a variety of ways set out below.

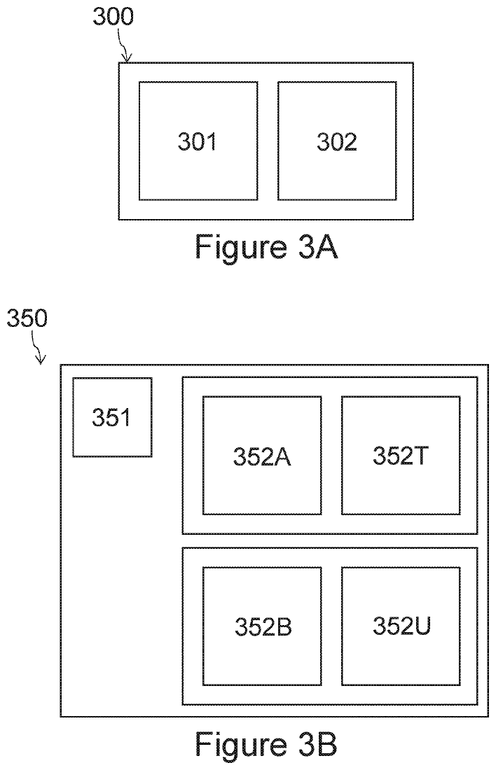

FIG. 3A illustrates an associated condition 300. The system 100 may generate an associated condition 300 based on the identifier 301 and the condition 302 determined by the image analyser 204. The identifier may be referred to as an associated condition. The associated condition 300 comprises the identifier 301 and the condition (i.e. that has been determined by the image analyser 204) 302. In examples, the system may determine that a given animal has more than one condition and, in such examples, all of these conditions is associated with the identifier.

The associated condition 300 may be stored on the computing device 122. The computing device 122 may display the associated condition 300. A farmer or veterinarian using the system may use the associated condition 300 to treat the animal.

FIG. 3B illustrates a profile 350 associating an identifier 301 associated with a unique animal and a first condition 352A is determined at a first time 352T, and a second condition 352B is determined at a second time 352U (e.g. later than the first time). In such examples, a profile for each animal may be provided which associates the identifier with each of the conditions along with the times at which the conditions were determined by the image analyser.

The profile 350 may be stored on the computing device 122. The computing device 122 may display the profile 350. A farmer or veterinarian using the system may use the profile 350 to treat the animal.

The computing device 122 may be a smartphone, tablet computer or personal computer (e.g. laptop or desktop) or a server (e.g. the cloud). The computing device 122 stores an associated condition 300 or profile 350 for each unique animal i.e. the identifier associated with the animal along with a determined condition of the foot of the animal.

In examples wherein the computing device 122 is a server, the computing device 122 is configured to communicate with a second computing device. The second computing device may be a smartphone, tablet computer or personal computer (e.g. laptop or desktop) which is configured to request and receive information about each animal i.e. an identifier of the animal and the determined condition of the animal. For example, the second computing device may be operated by a farmer or veterinarian located close to the animals so that they can retrieve information determined by the system which they can use to identify the animals with conditions of the feet and to also treat these animals.

In examples, the number of computing devices may not be limited to two. For example, there may be one or more control devices configured to control at least one of: the camera; sensors; the window clearing apparatus.

The machine learning algorithm may be stored on a local computing device or a remote computing device or may be distributed across a local computing device and a remote computing device.

The computing device 122 may be configured to generate a treatment timeline for each animal based on either a plurality of associated condition 300 unique to the animal or on the profile 350 associated with the animal. The treatment timeline may be displayed on the computing device 122. The treatment timeline may show the condition of the animal (e.g. on a y-axis displayed on the screen) against time (e.g. on an x-axis displayed on the screen). The treatment timeline may also show the time and nature of treatment provided to the animal. Thus, the change in condition of the animal can be shown relative to the administration of treatment.

The dispenser 114 is configured to dispense a substance into the footbath 106. In the example shown in FIG. 1, the dispenser 114 is disposed within the reservoir formed by the sides 106A-106D of the footbath 106. The dispenser 114 dispenses the substance into the footbath 106 based on the identifier and associated condition of the animal e.g. the dispenser is configured to receive the identifier and retrieve a condition associated with the identifier and then to dispense the substance based on the associated condition.

For example, an animal may be identified by reading the identifier tag of the animal using the identifier reader 112, this identifier is sent to the dispenser which then dispenses the substance e.g. if the given animal identified needs a specific treatment. The dispenser 114 may dispense a substance to treat the condition based on the receipt of the identifier and/or an indication of the condition of at least one of the feet of the animal.

The system may determine the magnitude of the condition (e.g. using mobility scores described herein). In such examples, the dispenser 114 may be configured to dispense an amount or concentration of the substance for treatment the condition based on the magnitude of the condition. Advantageously, for a low magnitude condition less substance for treatment can be dispensed, which may reduce the amount of substance which is wasted whereas for greater magnitude conditions more substance for treatment can be dispensed which may effectively treat the condition of the foot.

The gate 116 is for separating animals. The gate 116 is switchable between a first position 116A and a second position 116B (shown as a dashed line in FIG. 1). The first position 116A permits an animal to access a first region 117A and prevents the animal to access a second region 117B. The second position 116B permits the animal to access a second region 117B and prevents the animal to access a first region 117A.

The gate is configured to receive the identifier and is switchable between the first position 116A and the second position 116B based on the condition of the animal. For example, the gate 116 may receive the determined condition and be switchable based on the condition or the gate 116 may receive the identifier which is used by the gate to look up the condition of the animal having that identifier (e.g. by sending a query to the computing device which stores associated conditions or a profile).

For example, the first region 117A may be a holding pen to permit further inspection (e.g. manual inspection) of the animal and/or to permit treatment of the condition of the animal. The second region may 117B be to a field or barn or the like for animals which do not need to be treated. Thus the system may automatically segregate healthy animals from animals which have conditions of one or more feet.

The system is used the following manner. An animal (e.g. a cow such as a dairy cow) is introduced into the footbath 106 (e.g. using a cattle race). The animal steps over the entrance side 106A into the reservoir of the footbath 106. The animal triggers the first sensor 118 which sends a first signal to the camera 102. The camera 102 begins obtaining images. The identifier reader 112 determines the identity of the animal by reading the identity tag disposed on the animal (e.g. an ear RFID tag on the cow). The animal moves in the movement direction 106M and steps over the exit side 106B of the footbath 106 to exit the footbath. The camera 102 obtains images depicting the feet of the animal (e.g. the images may depict the hoof on the bottom of the foot). The camera 102 sends the obtained images to the image analyser 104.

The image analyser 104 executes the machine learning algorithm to determine if a condition is present on any of the feet depicted in the images or if the feet of the animal are healthy. The determined condition is associated with the identifier and sent to the computing device 122.

It will be appreciated that the system may comprise the image input and the image analyser only. The system may be provided at a location remote from the footbath, for example, in another room, building or even country. The image input may receive the one or more images, for example, wirelessly via a network such as the internet. The image analyser may execute the machine learning algorithm to thereby determine the condition of at least one foot of the animal based on the one or more images.

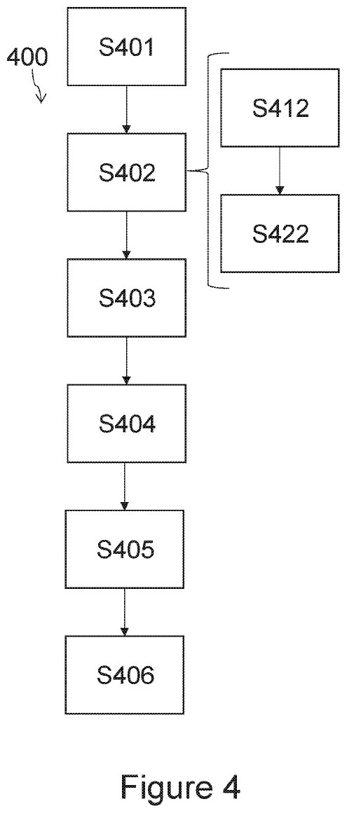

FIG. 4 illustrates a flowchart 400 illustrating a method of determining a condition of at least one foot of an animal.

The first step is to obtain, S401, one or more images, wherein a portion of each of the one or more images depicts at least one foot of the animal exiting a footbath.

In examples, one or more image may only be obtained in response to sensing an animal e.g. in the proximity of a camera for obtaining the images. For example, a motion sensor coupled to the camera may be employed to activate the camera to obtain one or more images in response to detecting motion of an animal by the sensor.

The second step is determine, S402, with a machine learning algorithm (e.g. an object detection algorithm) the condition of the at least one foot of the animal based on the one or more images.

The second step can be performed by completing a first substep S412 and a second substep S422.

The first substep is to perform, S412, image recognition on the obtained one or more images to identify the at least one foot of the animal in each of the one or more images; In practice, the first substep may comprise identifying the portion of each of the one or more image which depicts at least one foot of the animal exiting the footbath.

The second substep is to determine, S422, the condition of the at least one foot of the animal based on the identified at least one foot of the animal in the at one or more images.

The third step of the method is to identify, S403, the animal. This may comprise obtaining an indication of the identity of the animal (e.g. an identifier) by reading an identifier tag disposed on the animal. In examples, the animal may be identified based on markings on the animal (e.g. naturally occurring markings, such as a colour or pattern of the animal's fur and/or skin or artificial markings disposed on the animal, for example, paint disposed on the animal).

The fourth step of the method is to associate, S404, the identified animal and the determined condition. For example, the identifier associated with the animal may be associated with the determined condition and stored in a storage location, such as a computing device (e.g. computing device 122).

A fifth step of the method is to dispense, S405, a substance into the footbath based on the identity of the animal. For example, the determined condition may be sent to the dispenser and the dispenser may dispense a substance for treating the determined condition into the footbath.

The sixth step of the method is to operate, S406, a gate for separating animals based on the identity of the animal. Animals with a condition of the foot may be segregated from the animals without a condition of the foot.

A system such as the system described herein may be used to execute the method 400 (i.e. steps S401 and S402 and optionally substeps S412 and S422 and steps S403 to S406). A computing program product or a computing device may be provided to execute the second step or alternatively for executing the two substeps S412 and S422.

A computer program product may be provided which comprises instructions for execution by a processor which when executed by the processor cause the processor to perform the steps of the method 400.

A computer program product may be provided which comprises instructions for execution by a processor which when executed by the processor cause the processor to perform the substeps of the method 412 and 422.

Images in the first set depict one or more class of object which the algorithm is configured to identify within each image. Each class may be a different symptom indicative of a unique condition of the foot of the animal. For example, a first class may be a healthy condition of a cow's foot, that is a cows foot displaying no symptoms of illness. Another class may be a symptom of the condition of digital dermatitis (e.g. lesions) of a cow's foot.

The training data can be expanded to contain a third set of images wherein these images are indicative of another condition which is to be determined by the algorithm, for example, the third class may depict cow feet having another symptom indicative of another condition of the cow's foot.

The images in each class bear an associated class identifier. The feet depicted in the images may be classified into different classes wherein each class is characterised by levels of digital dermatitis (or other issues). The different classes may be identified by the severity of the digital dermatitis (e.g. using an International Committee for Animal Recording (ICAR) classification method). In examples, the images of the first class bear a class identifier ‘healthy’ indicating that the images in the first class depict healthy cow feet; the images of the second class bear a class identifier ‘digital dermatitis’ indicating that the images in the second class depict cow feet displaying the symptoms of digital dermatitis.

The learning of the algorithm is supervised, which means a human user marks out one or more bounding boxes of the objects to be detected by the algorithm. In practice this means that lesions depicted on the feet shown in the second set of images are circumscribed with a bounding box.

Based on the two sets of images with associated labels and the bounding boxes provided by the human user, the algorithm, can generate a trained model. In use, the algorithm receives a test image (e.g. the one or more images obtained by the image input and provided to the image analyser) and the test image is compared against the trained model. Based on the comparison the algorithm determines if the image depicts any of the class of objects. In the present example, the machine learning algorithm determines whether the test image displays lesions, thus belonging to the second group and, therefore, determining the condition of the animal's foot depicted in the image to be digital dermatitis.

The algorithm can also be trained to identify a portion of an image depicting a foot of an animal in a similar manner.

The term ungulate used herein refers to mammals with hooves i.e. the term ungulate may be replaced with ‘hooved mammal’.

The system may be configured to obtain one image or a plurality of images of the foot (or feet) of an animal. It will be appreciated that a plurality of images may be a video (e.g. merely a series of images obtained at a selected frame rate).

It will be appreciated that the system may not comprise the footbath. Instead the system may comprise the image input and the image analyser (along with any of the other optional features) and that the integers of the system are arranged relative to a footbath (e.g. a footbath provided by a third party).

In examples, the image input and the image analyser may be provided by a single apparatus e.g. device having a camera for obtaining the images connected to a processor for determining the condition.

In examples, the window may be provided or protected by a rollable film. The rollable film may comprise two rollers spaced disposed parallel and separate from one another and a film disposed around the two rollers and extending between the two rollers (e.g. in the manner of a cassette tape). The film extending between the rollers provides a clean window to permit images to be captured therethrough. When the film extending between the rollers needs to be refreshed (e.g. because fluid and/or debris is disposed on the film) then the rollers are rolled so that a fresh portion of the film is arranged to extend between the rollers.

Each profile is labelled with the identifier and associates the identifier with the determined condition and the time the condition was comprise an identity profile associated with each unique animal. The identity profile may comprise a plurality of associated conditions associated with a given animal. The identity profile may comprise a timeline of the conditions of the animal

A display device may be configured to retrieve an identity profile associated with a unique animal. The display device may be configured to send a request for an identity profile wherein the request comprises an identifier of the animal. The storage location may be configured to send the identity profile to the display device in response to the request. The identity profile may comprise a timeline indicating the condition against a time axis e.g. data showing no condition at a first time, data showing a condition having at a second time.

In examples, instead of determining the condition using an object detection algorithm, the condition may be determined using a machine learning algorithm configured to characterise movement of the animal. That is by an algorithm which may assess the perceived movement of the animal (i.e. between successive frames of the images) to determine if the animal has a condition e.g. if the animal is limping then the algorithm may determine that the animal has poor foot health. For example, an animal may be determined to be limping on a specific leg if the number of frames (e.g. the time) for which that leg is depicted as in contact with the ground is less than the other legs of the animal and/or if the number of frames of that leg is below an average number for that type of animal (e.g. cow). By using as training data one or more videos of an animal of a given type with each of: no condition; a first condition; a second condition etc. a machine learning algorithm can be obtained which associates the movement of the animal in a video with a condition of the animal.

In examples, the algorithm may determine a condition of the animal, wherein the determinable conditions are: a mobility score of 0; a mobility score of 1; a mobility score of 2; a mobility score of 3. For example, the algorithm may be configured to classify videos (i.e. a plurality of images provided in a sequence) into a plurality of classes, for example, a first class corresponding to animals with a mobility score of 0, a second class corresponding to animals with a mobility score of 1, a third class corresponding to animals with a mobility score of 2, a fourth class corresponding to animals with a mobility score of 3.

The algorithm may be trained based on labelled videos (i.e. a plurality of images provided in a sequence). The labelled videos may comprise: a plurality of videos depicting cows with a mobility score of 0 and labelled the same; a plurality of videos depicting cows with a mobility score of 1 and labelled the same; a plurality of videos depicting cows with a mobility score of 2 and labelled the same; a plurality of videos depicting cows with a mobility score of 3 and labelled the same. The algorithm may generate a model based on these videos and labels. Comparison of video footage depicting a cow walking with the model may permit a determination of the condition of the foot of the cow (i.e. the mobility score of the cow).

Advantageously, the system may perform a mobility scoring rather than a human, which may comparatively reduce the cost and/or time of mobility scoring and/or which may comparatively improve accuracy of mobility scoring.

Wireless connections described herein configured to exchange data such as images or indications of a condition may be one or more wireless connections, such as a Bluetooth® and/or Zigbee® network or any other at least partially wireless network such as internet excess via Wi-Fi®.

Although use of a footbath has been disclosed, it will be understood that in other examples a footbath is not essential, and embodiments of the disclosure do not require the use of a footbath.

In examples a system is provided for determining a condition of at least one foot of an animal, the system comprising: an image input configured to obtain one or more images, wherein a portion of each of the one or more images depicts at least one foot of the animal; and an image analyser comprising a machine learning algorithm configured to determine the condition of the at least one foot of the animal based on the one or more images. For example, the image depicts an underside of the foot of the animal.

In examples, the system may comprise a step or obstacle of the like which an animal must lift its foot thereover thereby to present the foot to a camera which obtains images for the image input. In examples, no obstacle or footbath is provided and the condition is determined based on the movement of the animal (e.g. part of an animal, such as an upper portion of an animal, which is visible in a video) in a video.

It will be appreciated that one or more images referred to herein, may be a corresponding number of frames from a video (e.g. successive frames or frames obtained with a given spacing, for example, every fifth frame of a video is used for the determination).

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

Any processors used in the computer system (and any of the activities and apparatus outlined herein) may be implemented with fixed logic such as assemblies of logic gates or programmable logic such as software and/or computer program instructions executed by a processor. The computer system may comprise a central processing unit (CPU) and associated memory, connected to a graphics processing unit (GPU) and its associated memory. Other kinds of programmable logic include programmable processors, programmable digital logic (e.g., a field programmable gate array (FPGA), a tensor processing unit (TPU), an erasable programmable read only memory (EPROM), an electrically erasable programmable read only memory (EEPROM), an application specific integrated circuit (ASIC), or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide the data store of the computer system (and any of the apparatus outlined herein).

Other examples and variations of the disclosure will be apparent to the skilled addressee in the context of the present disclosure.

1. A system for determining a condition of at least one foot of an animal, the system comprising:
an image input configured to obtain one or more images, wherein a portion of each of the one or more images depicts at least one foot of the animal exiting a footbath; and
an image analyser comprising a machine learning algorithm configured to determine the condition of the at least one foot of the animal based on the one or more images.

2. The system of claim 1, wherein:
the machine learning algorithm is configured to:
perform image recognition on the obtained one or more images to identify the at least one foot of the animal in each of the one or more images; and,
determine the condition of the at least one foot of the animal based on the identified at least one foot of the animal in the at one or more images.

3. The system of claim 2 wherein:
the machine learning algorithm is configured to:
perform image recognition on the obtained one or more images to identify the at least one foot of the animal in each of the one or more images by identifying the portion of each of the one or more image which depicts at least one foot of the animal exiting the footbath.

4. The system of claim 1 wherein:
the machine learning algorithm comprises an object detection algorithm.

5. The system of claim 1 wherein:
the image input is a camera, and wherein:
the camera receives light for obtaining an image via a window; and,
wherein the system comprises:
a window clearing assembly configured to clear the window.

6. (canceled)

7. The system of claim 5, wherein:
the window clearing assembly comprises at least one of:
a movable member configured to wipe the window to thereby clear the window;
the window clearing assembly comprises an air blower configured to blow air on the window to thereby clear the window.

8. The system of claim 5, comprising:
a sensor configured to generate a signal in the event that an animal is sensed by the sensor within a sensing region of the sensor,
wherein the camera is configured to obtain an image in response to the signal.

9. The system of claim 5, further comprising a data collection apparatus including:
a first sensor configured to generate a first signal in the event that an animal is sensed by the first sensor within a first sensing region of the first sensor; and,
a second sensor configured to generate a second signal in the event that an animal is sensed by the second sensor within a second sensing region of the second sensor;
wherein the camera is configured to:
start obtaining images in response to the first signal;
cease obtaining images in response to the second signal;

10. The system of claim 1 wherein:
the image input is a port configured to receive one or more images obtained from a camera.

11. The system of claim 1 wherein:
the footbath comprises:
an entrance side wherein an animal steps over the entrance side to enter the footbath; and,
an exit side wherein an animal steps over the exit side to exit the footbath, and wherein the exit side is disposed opposite the entrance side so that during use the animal moves in movement direction, wherein the movement direction is defined from the entrance side towards the exit side; and,
wherein camera is disposed at the exit side of the footbath and arranged to view in the movement direction.

12. The system of claim 1, comprising:
an identifier reader configured to read an identifier from an identifier tag disposed on the animal;
and wherein the system is configured to generate an associated condition wherein the associated condition comprises a condition and an associated identifier, the system further comprising:
a dispenser configured to dispense a substance into the footbath, wherein the dispenser is configured to dispense the substance into the footbath based on the associated identifier, wherein the dispenser is configured to:
dispense a given amount of the substance into the footbath based on the associated identifier.

13. (canceled)

14. (canceled)

15. The system of claim 12, the system further comprising:
a gate for separating animals, wherein the gate is switchable between a first position and a second position, wherein:
the first position permits an animal to access a first region and prevents the animal to access a second region; and,
the second position permits the animal to access a second region and prevents the animal to access a first region; and,
the gate is configured to receive the identifier;
the gate is switchable between the first position and the second position based on the associated identifier.

16. The system of claim 1, wherein the condition is digital dermatitis of cattle.

17. A method for determining a condition of at least one foot of an animal, the method comprising:
obtaining one or more images, wherein a portion of each of the one or more images depicts at least one foot of the animal exiting a footbath; and
determining with a machine learning algorithm the condition of the at least one foot of the animal based on the one or more images.

18. The method of claim 17, wherein:
determining with a machine learning algorithm the condition of the at least one foot of the animal based on the one or more images comprises:
performing image recognition on the obtained one or more images to identify the at least one foot of the animal in each of the one or more images; and,
determining the condition of the at least one foot of the animal based on the identified at least one foot of the animal in the at one or more images.

19. The method claim 18 wherein:
performing image recognition on the obtained one or more images to identify the at least one foot of the animal in each of the one or more images comprises:
performing image recognition on the obtained one or more images to identify the at least one foot of the animal in each of the one or more images by identifying the portion of each of the one or more image which depicts at least one foot of the animal exiting the footbath.

20. The method of claim 17, wherein the machine learning algorithm comprises an object detection algorithm.

21. The method of claim 17, comprising:
sensing an animal; and,
obtaining an image in response to sensing the animal.

22. The method of claim 17 comprising:
identifying an animal;
associating the identified animal and the condition, further comprising at least one of:
dispensing a substance into the footbath based on an identity of the animal;
operating a gate for separating animals based on the identity of the animal.

23. (canceled)

24. (canceled)

25. A non-transitory computer readable medium comprising instructions that, when executed by a programmable processor, cause the processor to:
determine with a machine learning algorithm a condition of at least one foot of an animal based on one or more images by:
performing image recognition on the one or more images to identify the at least one foot of the animal in each of the one or more images; and,
determining the condition of the at least one foot of the animal based on the identified at least one foot of the animal in the at one or more images.
